(19) United States
(12) Patent Application Publication
(10) Pub. No.: US 2020/0390122 A1
(43) Pub. Date: Dec. 17, 2020

(54) COFFEE BEANS HAVING IMPROVED SHELF LIFE BY UTILIZING CANNABINOIDS AND METHOD OF INFUSION

(71) Applicant: Steep Fuze, LLC, Boulder, CO (US)

(72) Inventor: Devin Jamroz, Boulder, CO (US)

(21) Appl. No.: 17/002,635

(22) Filed: Aug. 25, 2020

Related U.S. Application Data
(63) Continuation of application No. 15/726,826, filed on Oct. 6, 2017.
(60) Provisional application No. 62/407,595, filed on Oct. 13, 2016.

(51) Int. Cl. A23F 5/14

(52) U.S. Cl. CPC A23F 5/14

(57) ABSTRACT

A whole coffee bean manufactured by the process of providing roasted coffee beans including a surface and naturally occurring lipids, mixing a cannabinoid solution including lipophilic cannabinoids and a polar solvent having at least 90% ethanol by volume to yield an ethanol solution, applying the ethanol solution to the roasted coffee beans, evaporating the polar solvent from the beans to enable lipophilic attraction between the naturally occurring oils in the coffee beans and the cannabinoids. The ethanol and the cannabinoids cooperate to inhibit pathogenic microbial growth by sterilizing the surface of the coffee bean, whereby the coffee bean is imparted an improved shelf life exceeding the shelf life of control by at least 10%.

### FIELD OF THE INVENTION

This invention pertains to coffee infused with cannabinoids.

### BACKGROUND AND SUMMARY OF THE INVENTION

Cannabinoids are molecules that interact with the endocannabinoid system of humans. Many cannabinoids are known to trigger various endocannabinoid receptors including the CB1 and CB2 receptors.

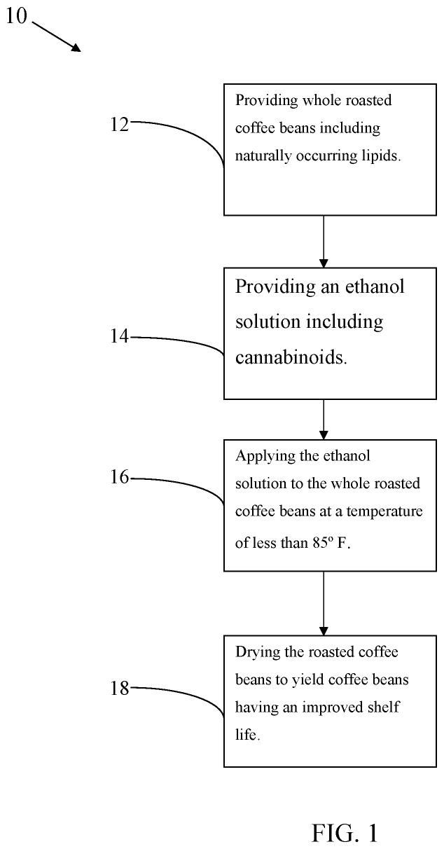

Cannabinoids can be produced within the human body and these are called endocanabinoids. Phytocannabinoids are produced by plants. Synthetic cannabinoids are typically produced in laboratory environments. There are over one hundred known phytocannabinoids produced by plants. The most well-known phytocannabinoid molecules are trans-Δ9-tetrahydrocannabinol (THC) and cannabidiol (CBD). These are depicted below in FIG. 1 and FIG. 2.

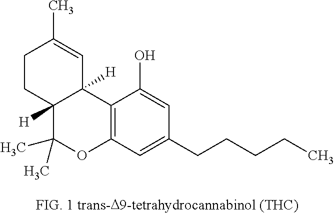 [SMILES: CCCCCc1cc(O)c2c(c1)OC(C)(C)[C@@H]1CCC(C)=C[C@@H]21]

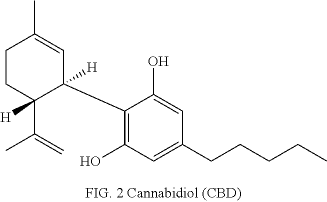 [SMILES: C=C(C)[C@@H]1CCC(C)=C[C@H]1c1c(O)cc(CCCCC)cc1O]

Many people suffering from chronic and acute conditions benefit from modulation or activation of these receptors to control inflammation, pain and numerous other neurological and physiological conditions.

One difficulty expressed by medical practitioners is that patients often forget, neglect, or disregard advice pertaining to consumption of necessary medicines. It is common for the infirm to refuse, or forget to take pills or other medication on a daily basis.

The present invention seeks to enable people to consume the nutrients and health remedies that they desire by integrating them into their normal diet. Coffee, for example, is consumed daily by more than half of Americans.

Infusing a food product with supplements has occurred for decades. For example, fortified cereals and rice are consumed daily by many. Such grains are infused with necessary nutrients to maintain and promote health. Foods that provide health benefits are termed “functional foods”.

In general, functional food ingredients that have a long history of consumption are not required to be tested or approved by the FDA in the U.S. because they are Generally Recognized as Safe (GRAS). Cannabis products including hemp have been consumed as food for thousands of years and are evidently safe under this standard.

U.S. Pat. No. 8,734,885 B2 provides a way of infusing coffee beans with nutrients in a water-based solution with an acidic pH to effectuate the infusion.

U.S. Patent Publication No. 20130177680 A1 provides a way of roasting flavoring seeds. A water-based solution is utilized.

One problem with water-based solutions is that they may not evaporate quickly enough. This can enable colonization by pathogenic microbes that tend to grow on moist cellulosic substrates. Pathogenic microbes can contaminate food product with toxic metabolites such as aflatoxin. Microbial action can reduce shelf life of food products including coffee.

The antibacterial, antiviral and antifungal properties of cannabinoids from the cannabis plant have been studied. Italy's Universita del Piemonte Orientale and Britain's University of London, School of Pharmacy assessed the antibacterial properties of cannabinoids against various strains of multidrug-resistant bacteria, including MRSA. The conclusion was that cannabinoids have “exceptional” antibacterial activity.

What is desired is a way of enabling people to receive the nutrients and supplements that they desire in a way that they will not neglect, refuse or forego. What is also desired is a way of infusing nutrients and supplements without increasing risks associated with pathogenic microbial growth. What is further desired is a way of increasing the shelf life of food products.

### DETAILED DESCRIPTION

The present invention includes the step of providing roasted coffee beans and infusing the coffee beans with an alcohol solution containing a cannabinoid.

In one embodiment, the cannabinoid is purified CBD having a purity of 96% or greater prior to combining in solution with the alcohol, which has a purity of 80% or greater prior to combining into solution with the cannabinoid. Preferably the alcohol has a purity of between 94% and 96% prior to combining with the cannabinoid.

The alcohol solution, in one embodiment of the invention, has between 5-15% CBD on a mass to mass basis. Preferably the alcohol solution has between 9-10% CBD on a mass to mass (w/w) basis.

The alcohol solution, in another embodiment of the invention, has between 5-15% CBD on a volume to volume basis. Preferably the alcohol solution has between 9-10% CBD on a volume to volume (v/v) basis.

In another embodiment of the invention the alcohol solution includes a whole plant extract of hemp having less than 0.3 percent THC. More preferably, the whole plant extract has non-detectable levels of THC. In a variation of this embodiment, the THC levels are less than 25 parts per million of the alcohol solution.

Preferably, the whole plant extract has been processed to remove most residual chlorophyll a portion of waxes. Processing may include filtering, precipitating or other method known to separate chlorophyll and wax from whole plant extracts. The whole plant extract contains between 30-80% CBD on a w/w basis. More preferably the whole plant extract contains 60-70% CBD on a w/w basis.

In an alternate embodiment, the hemp flower, leaf, stems, or combination thereof are immersed in alcohol (80-99%) that has been cooled to below −10° C., and more preferably cooled between −30° C. and −15° C. to extract cannabinoids from the plant matter. The alcohol solution is separated from the plant material and adjusted to a desired cannabinoid concentration to yield the alcohol solution, which contains cannabinoids such as CBD.

The process of the present invention includes roasting green coffee beans and applying the alcohol solution to the surface of the roasted beans. Next the process enables enabling the roasted beans to dry within one minute of coining into contact with the alcohol solution. This can be accomplished by passing laminar or turbulent air across the surface of the roasted beans.

The alcohol renders almost all biological surface contaminants inert. The alcohol may also and may even help to reduce mycotoxin levels in the roasted beans. The surface contaminants rendered inert include fungal spores which are often heat-resistant.

There are indications that the CBD is more stable oil than aromatic and other oils naturally occurring in roasted coffee beans. Accordingly, the cooperation of the naturally occurring oils in the roasted coffee with the CBD, which is an oil, two stabilizes the flavor of the roasted coffee and extends the shelf life of the roasted coffee.

A portion of the naturally occurring coffee oils are mobilized by application of the alcohol solution. Some of these oils and the cannabinoids reabsorb into the coffee beans. The process does, however, result in a greater concentration of the cannabinoid and coffee oils on the surface of the roasted coffee beans. This yields a lipid-encapsulated whole roasted coffee bean. The lipid-encapsulation further increases the shelf life of the roasted coffee beans and also inhibits microbiological contamination of the surface of the roasted coffee beans, which over time, can adversely affect the coffee bean flavor and aroma. Further the lipid-encapsulation of the whole roasted coffee beans improves shelf life by reducing oxidation and other reduction of the flavor and aroma components within the coffee beans. The CBD oil on the outside of the roasted coffee beans further has anti-microbial properties that inhibit degradation of the lipid-encapsulation process.

Roasting coffee beans express a portion of oils naturally occurring in the coffee and caramelized sugar oils to the surface which contact the CBD when the alcohol solution is applied to the coffee beans and thereafter. Over the course of 2-4 days after application of the alcohol solution a portion of these oils reabsorb into the beans as the beans de-gas or “rest”. This process brings the CBD (and all of its antimicrobial properties) into the actual bean and that may inhibit microbial action within the roasted coffee beans, and further stabilize the flavor and improve shelf life.

### EXAMPLE #1

In one embodiment of the process of the invention utilizes approximately 500 ml of alcohol solution of per 10 pounds of roasted coffee beans. This is a approximately 50 ml per pound of roasted coffee beans.

The step of adding more alcohol solution to the roasted coffee beans can add up to 10 ml per pound of extra alcohol solution o achieve the desired consistency and potency of CBD in the roasted coffee beans. Preferably the step of adding more alcohol solution adds less than 3-4 ml extra alcohol solution per pound.

In one embodiment the whole plant extract of cannabis is between 50%-70% cannabinoid concentration, and preferably 65% cannabinoid concentration, which is added to the alcohol to make the alcohol solution.

Lower than that, the oil has too much residual flavor and higher than that, the oil is too viscous, does not absorb into the beans as well, and can make the beans sticky.

The ideal ambient temperature for this process is about 75 degrees at 1 ATM of pressure. Lower than that and the water does not evaporate fast enough and hotter than that and the alcohol evaporates too quickly and we cannot evenly coat all the beans. In an alternate embodiment, the temperature at which the alcohol solution is applied is between 65 and 85 degrees F. Preferably, the beans are cooled after roasting to this temperature range. It can be appreciated that the process can be modified and the pressure regulated to vary this temperature range.

Coffee beans according to the present invention include arabica coffee beans, which typically contain more lipids in a concentration of 15-17%.

Coffee beans further include robusta beans having a lipid concentration of between 10-11.5%, respectively. The majority of these lipids are contained in the endosperm of green coffee beans. A small portion is contained in the waxy portion covering the green coffee bean.

Coffee beans having a lipid concentration of over 14% are preferred for the present invention. Table 1 below provides a glimpse of an example of lipid concentrations in green coffee beans. During roasting, the lipids (as well as caffeine) remain virtually unchanged owing to their relatively high melting points. The lipids that survive roasting interact and cooperate with the lipids in the cannabinoid extract to achieve the aims of the present invention.

TABLE 1

| COMPONENT | % LIPIDS |
|---|---|
| Triglycerides | 75.2 |
| Esters of Diterpene Alcohols & Fatty Acids | 18.5 |
| Diterpene Alcohols | 0.40 |
| Esters of Sterol & Fatty Acids | 3.2 |
| Sterol | 2.2 |
| Tocopherols | 0.04-0.06 |
| Phosphatides | 0.1-0.5 |
| Tryptamine Derivatives | 0.6-1.0 |

Referring to Table 1, the triglycerides and diterpenes are most responsible for attracting cannabinoid lipids, including CBD.

The diterpene triglycerides bind to and improve the dispersal of the CBD when the CBD is applied to the roasted coffee beans. In one embodiment of the invention, diterpene triglycerides are added to the cannabinoid extract to modulate and optimize this effect. Preferably the added diterpene triglycerides are derived from coffee beans.

In a preferred embodiment of the process of the present invention, the roasted beans are infused with the alcohol solution within 6-12 hrs of roasting. In an alternate embodiment, the roasted beans are infused no longer than 48 hrs after roasting. Further delay can reduce the efficacy of the process.

In accordance with the process of the present invention, the beans need to rest for a minimum of 2-4 days post-infusion with the alcohol solution to degas and optimally re-absorb the mixture of cannabinoid and coffee oils. In an alternate embodiment, the time is 2-9 days, depending on the temperature of the infused coffee beans. During this resting process any alcohol that may have been absorbed into the bean which did not evaporate immediately off the surface will evaporate off.

The absorption of the alcohol solution inhibits increased moisture absorption by the coffee beans. This enables the process to be performed even in open-air and humid conditions.

The relatively cold temperature range used for the infusion process i.e. <85 degrees F., prevents the beans from steeping in the alcohol solution and brewing the alcohol solution into coffee during the infusion process.

The coffee manufactured by the present invention includes a shelf life exceeding 10% of the shelf life over control coffee without application of the alcohol solution. Under optimal storage conditions of humidity and temperature this shelf life can be further improved. Under poor storage conditions where the temperatures and humidity exceed 80° F. and 60% humidity, respectively, the lipid encapsulation and absorption of the roasted coffee beans yields even more significant shelf life figures. Shelf life can be measured analytically, or subjectively with taste tests, in accordance with current industry practices.

What is claimed is:

1. A method of infusing coffee beans with a cannabinoid extract, comprising:
providing roasted coffee beans including a surface and naturally occurring lipids;
providing an ethanol solution including lipophilic cannabinoids and ethanol;
applying the ethanol solution to the roasted coffee beans at a temperature of less than 85 degrees F.; and
drying the roasted coffee beans,
whereby the ethanol and the cannabinoids cooperate to improve shelf life of the roasted coffee beans.

2. The method as set forth in claim 1, wherein the naturally occurring lipids include kahweol and cafestol, the naturally occurring lipids pull the lipophilic cannabinoids into the coffee beans to enable the cannabinoids to directly inhibit microbial activity within the coffee bean and on the surface of the coffee bean.

3. The method as set forth in claim 1, further comprising agitating the roasted coffee beans to disperse the ethanol solution on the coffee beans.

4. The method as set forth in claim 1, wherein the ethanol solution has a concentration of at least 80% and the cannabinoids have a concentration of at least 5% on a volume to volume basis.

5. The method as set forth in claim 3, wherein the ethanol has a concentration of greater than 90% and the cannabinoids have a concentration of at least 9% on a volume to volume basis.

6. The method of claim 1 wherein the lipophilic cannabinoids include cannabidiol.

7. The method of claim 1 wherein the lipophilic cannabinoids include trans-Δ9-tetrahydrocannabinol (THC).

8. A whole coffee bean manufactured by the process:
providing roasted coffee beans including a surface and naturally occurring lipids;
providing a cannabinoid solution including lipophilic cannabinoids and a polar solvent having at least 90% ethanol by volume;
applying the solution to the roasted coffee beans;
evaporating the solvent from the beans to enables lipophilic attraction between the naturally occurring oils in the coffee beans and the cannabinoid extract to infuse the coffee beans with the lipophilic cannabinoids; and
the ethanol and the cannabinoids cooperate to inhibit pathogenic microbial growth by sterilizing the surface of the coffee beans, and by accelerating evaporation of the solution to further inhibit microbial growth,
whereby the coffee beans are imparted an improved shelf life.

9. The whole coffee bean as set forth in claim 8, wherein the total cannabinoids in the coffee beans is 0.1% on a weight to weight (w/w) basis.

10. The whole coffee bean as set forth in claim 9, wherein the cannabinoid is cannabidiol, which includes 5-15% cannabidiol acid, and between 15-90% decarboxilated cannabidiol.

11. The whole coffee bean as set forth in claim 8, wherein the total cannabinoids in the coffee beans is between 0.05% to 0.2% on a weight to weight (w/w) basis.

12. The whole coffee bean as set forth in claim 8, wherein the cannabinoids are phytocannabinoids derived from hemp.

13. The whole coffee bean as set forth in claim 8, wherein the cannabinoids are phytocannabinoids not derived from hemp.

14. The whole coffee bean as set forth in claim 8, wherein the cannabinoids are synthetic cannabinoids.
